(19) United States
(12) Patent Application Publication
(10) Pub. No.: US 2019/0191058 A1
(43) Pub. Date: Jun. 20, 2019

(54) PRINTER ADJUSTMENT BASED UPON IMAGE DISPLAY ENVIRONMENT ILLUMINATION

(71) Applicant: Hewlett-Packard Development Company, L.P., Houston, TX (US)

(72) Inventors: Jonathan Neuneker, Boise, ID (US); Shaun Henry, Boise, ID (US); Gregory D Creager, Boise, ID (US)

(21) Appl. No.: 16/093,470

(22) PCT Filed: Jul. 21, 2016
(86) PCT No.: PCT/US16/43323

§ 371 Date: Oct. 12, 2018

(51) Int. Cl. H04N 1/60

(52) U.S. Cl. CPC H04N 1/6086

(57) ABSTRACT

A printer operational parameter adjustment controller may include a processing unit and instructions The processing unit is to follow the instructions to adjust operational parameters of a printer located in a second environment, different than the first environment, based upon the stored display illumination profile for a first environment to print the image captured in a third environment different than the first environment.

### BACKGROUND

Printers are typically provided with default operational parameters controlling how ink or other printing materials are applied to a print medium when printing an image. Such default operational parameters are typically based upon lighting having a color temperature of 5000 K.

### BRIEF DESCRIPTION OF THE DRAWINGS

FIG. 1 is a schematic diagram of an example printing system.

FIG. 2 is a flow diagram of an example method for adjusting operational parameters of a printing device based upon illumination data for a display environment.

FIG. 3 is a schematic diagram of an example printing system.

FIG. 4 is a schematic diagram of an example printing system.

FIG. 5 is in a schematic diagram of an example printing system.

FIG. 6 is a schematic diagram of an example printing system.

### DETAILED DESCRIPTION OF EXAMPLES

Operational parameters of printers control how ink or other printing materials are applied to the print medium when printing an image. Printers are typically provided with default operational parameters that are based upon lighting having a color temperature of 5000 Kelvin (K). Color temperature refers to the overall color of the lighting source. The images printed by such printers and their default operational parameters are not well-suited for being displayed or presented in many lighting environments.

The present disclosure describes various printing systems that adjust or change the operational parameters of the printer itself based upon illumination data for the environment in which the image is to be displayed or presented, independent of the lighting conditions present when the image was captured or the lighting conditions present for the printer printing the image. The same captured digital image may be differently printed by the same printer for display in different environments. In addition, adjustments of the operational parameters of a printer for a particular display environment may be applied in a blanket fashion to all images to be displayed in the particular display environment. Because the operational parameters of the printer itself are adjusted, rather than the captured digital image being adjusted, the original captured digital image may be preserved. Moreover because such illumination adjustments are made “further downstream” at the printer level by adjusting the operational parameters of the printer itself, rather than making illumination adjustments at the captured image level, such adjustments for a given image display environment may precisely take into account particular printing characteristics of the printer itself that is actually printing the image. A single printing correction may be applied.

By maintaining the original image and applying the color correction at the printing stage, the example printing systems allow an original image to be printed with customized color correction for multiple display locations, thereby enhancing the color settings for one or more destinations that will display the image. The technique may be applied to all forms of printing, including, but not limited to ink, toner, liquid toner, wax, digital, analog and the like. In one implementation, the technique is employed on a digital printing device that has the ability to dynamically adjust the print color settings on a per page or per image basis, thus enabling any image on any printed page to have it's color customized such that a given image color management will be enhanced for it's target display environment.

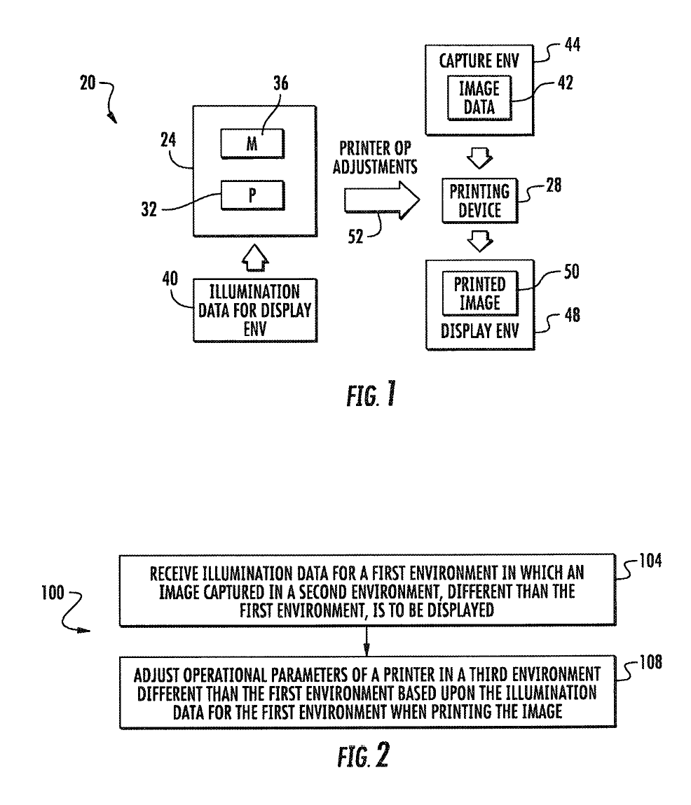

FIG. 1 schematically illustrates an example printing system 20. As will be described hereafter, printing system 20 adjusts or changes the operational parameters of the printer itself based upon illumination data for the environment in which the image is to be displayed or presented, independent of where the image was captured, independent of the circumstances in which the image was generated (such as on a computer) or independent of where the image is being printed. Printing system 20 comprises a printer operational parameter adjustment controller 24 for use with a printing device 28.

Printing device 28 comprises a device that deposits the printing material or applies a printing material onto a print medium. Printing device 28 may comprise any of a variety of different printing devices employing different printing mechanisms for forming an image on a print medium. For example, printing device 28 may comprise a device that deposits ink or device that deposits toner onto a print medium. Such printing devices have operational parameters that control how the printing material, such as ink or toner, is deposited or applied to the print medium. In one implementation, printing device 28 may comprise a digital printing press

Controller 24 adjusts the operational parameters (OP) of printing device 28 by outputting control signals which are transmitted to printing device 28. Controller 24 comprises processing unit 32 and memory 36. For purposes of this application, the term “processing unit” shall mean a presently developed or future developed computing hardware that executes sequences of instructions contained in a memory, such as memory 36. Execution of the sequences of instructions causes the processing unit to perform steps such as generating control signals. The instructions may be loaded in a random access memory (RAM) for execution by the processing unit from a read only memory (ROM), a mass storage device, or some other persistent storage. In other embodiments, hard wired circuitry may be used in place of or in combination with software instructions to implement the functions described. For example, controller 24 may be embodied as part of one or more application-specific integrated circuits (ASICs). Unless otherwise specifically noted, the controller is not limited to any specific combination of hardware circuitry and software, nor to any particular source for the instructions executed by the processing unit.

Memory 36 comprises a non-transitory computer readable medium that contains instructions for directing processor 32 to carry out method 100 described with respect to FIG. 2. Although method 100 is described with respect to printing system 20, method 100 may be carried out by any of the rating system described hereafter. As indicated by block 104 in FIG. 2, the instructions contained in memory 36 direct processor 32 to acquire or receive illumination data 40 for a display environment, the first environment in which the captured image is to be presented or displayed.

As shown by FIG. 1, the captured image to be printed may be in the form of image data 42. The image data 42 has associated lighting characteristics that are the result of the environment in which the image was captured, capture environment 44. Capture environment 44 has illumination or lighting characteristics that are distinct from the illumination or lighting characteristics of display environment 48, the environment in which the image to be printed is to be presented or displayed.

For example, a digital photograph may be captured at a first location with first lighting conditions. The first lighting conditions will result in image data 42, wherein the digital values for the individual pixels of the digital image will depend upon the first lighting conditions at the time that the digital photograph was taken. A print of the digital photograph may be displayed or presented under completely different second lighting conditions. For example, the print of the digital photograph may be displayed at a different location having different ambient light or different controlled lighting as compared to the first lighting conditions. In some circumstances, the print of the digital photograph may be displayed in the same location that the digital photograph was taken, but under different lighting conditions then those lighting conditions that were present when the digital photograph was taken.

As indicated by block 108 in FIG. 2, controller 24 adjusts the operational parameters of printing device 28, the printer, based upon the illumination data for the first environment, display environment 48, when printing using the image data 42. As shown by 1, the display environment 48, the lighting conditions of display environment 48, are different than the environment in which the image is actually being printed. Although the printing device 28 may be located in a printing environment having particular lighting conditions, controller 24 adjusts the operational parameters of printing device 28, not based upon the lighting conditions that exist for the printer, but based upon the lighting conditions that will be present in display environment 48 when the printed image 50 is to be displayed. For example, a digital photograph may be taken under low light conditions and printed by a printer residing in environment having low light conditions. Despite such image capture and printing environments having low light conditions, controller 24 may provide printer operational parameter adjustments 52 to printing device 28 that alter the operational parameters of printing device 28 such that the printed image 50 has illumination characteristics that enhance the presentation of printed image 50 under bright conditions, such as when printed image 50 is showcased by a spotlight.

Adjustments for an image, page or print job job may include, but are not limited to: ICC (International Color Consotium) Profile, Color LUT (Look Up Table), hue, contrast, luminance, etc. . . . . In a digital printer, where each image, page and/or job can be processed differently on-the-fly, in real-time, the application of color management settings is for a given display environment. An example of a commercially available digital printing press that can process images, pages and jobs in this fashion is the HP Indigo Digital Press.

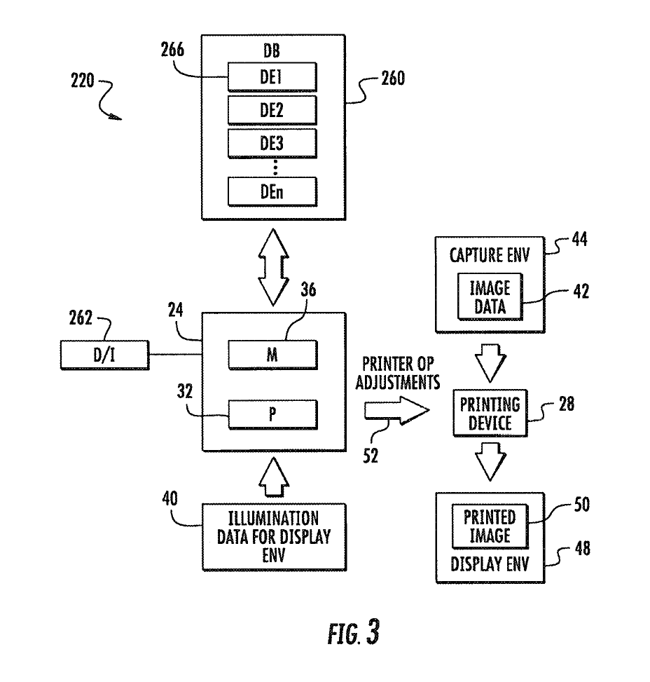

FIG. 3 schematically illustrates an example printing system 220. Printing system 220 is similar to printing system 20 described above except that printing system 220 additionally comprises database (DB) 260 and display/input device 262. Those remaining components of printing system 220 which correspond to components of printing system 20 are numbered similarly.

Database 260 comprises a memory storing display illumination profiles for different display environments. In the example illustrated, database 260 stores display illumination profiles 266 for different display environments (DE₁, DE₂, DE₃ . . . DEₙ). Each display illumination profile 266 comprises at least one lighting value or piece of lighting data for the particular display environment. For example, each display illumination profile 266 may include information such as a relative spectral power distribution associated with a lighting source in the environment or lighting sources themselves. A color profile may contain data in the form of CIE (Commission International de l'Eclairage or International Commission on Illumination) try stimulus values (XYZ) which serve to represent relative spectral power distribution or other characteristic data of a particular lumen or light source in a viewing environment. Each display illumination profile may include information such as aluminate conditions such as daylight, fluorescent lighting, incandescent lighting, halogen lighting or the like. In another implementation, rather than each display illumination profile 266 being based upon the light source itself, each display illumination profile 266 may instead or additionally comprise sensed lighting or illumination data taken in the associated display environment. For example, such data may be acquired using an optical spectrometer that measures properties of life the location in which the ultimate printed image is to be presented or displayed. Such data is associated with the particular display environment and stored in database 260.

The display illumination profiles 266 stored in database 260 may be associated with different geographic locations, different physical locations at the same geographic location or with respect to different display times at the same physical location or the same geographic location. For example, different geographic locations may have different associated lighting conditions. Different locations at the same geographic location, such as different locations in one room may have different lighting conditions. Depending upon the time of day or time of year, the same geographic location or even the same physical location may have different lighting conditions. For example, depending upon the location of windows in a room, a certain wall in the room may experience different lighting conditions depending upon the time of day as well as the time of year (fall, spring, summer or the particular month). The different display illumination profiles 266 may take into account what times of the day the printed image will be presented for viewing. The different display illumination profiles may take an account whether the printed image was presented in the fall in a particular room or at a particular geographic location or whether the printed image will be presented in the spring or summer, where controller 24 adjust the operational parameters of printing device 28 based upon the particular display illumination profile to adjust operational printing device 28 to fine tune the characteristics of the printed image for enhanced viewing of the printed image.

In one implementation, database 260 may comprise multiple different display illumination profiles 266 for the same physical location at different times of the day, multiple different display illumination profiles 266 for the same physical location at different times of the year or different months, multiple different display illumination profiles 266 for the same physical location at different times of the day and different times of the year, and multiple different display illumination profile 266 for different geographic locations, each geographic location having multiple associated display illumination profiles for different times of the year, each different time of the year having multiple different display illumination profiles for different times of the day. In some implementations, the lighting condition for a particular physical location may be controllable by the end-user, such as when a user has the ability to adjust the illumination of the printed image by adjusting the power output of a light source. In such an implementation, database 260 may comprise a different display illumination profile 266 for each of the illumination settings available for selection by the end-user at the particular physical location.

In one implementation, values for different illumination data or lighting data may be taken or acquired using a light sensing device, such as with a spectral photometer, at a particular geographic location, a particular physical location and/or different times of the day or times of the year. The illumination or lighting data may be stored in digital files along with metadata identifying non-lighting characteristics of display environment such as geographic coordinates, vertical height, wall location, time of year that measurements were taken and/or time of day that measurements were taken. In one implementation, the metadata is input by the user capturing the lighting data. In one implementation, at least some of the metadata is automatically acquired. For example, in one implementation, the light sensing device may comprise a global positioning sensing system (GPSS) and a clock which automatically associate the physical location, time and date metadata with the acquired lighting data. Such acquired illumination data may be uploaded or transmitted in a wired or wireless fashion to a server that manages database 260. Database 260 stores the different display illumination profiles for subsequent use when printing multiple different images as requested by multiple users for images captured at different locations.

In one implementation, database 60 further comprises a link/map from one or more of the CIE profiles to one or more given press configuration profiles. For example, database 260 may contain a mapping of CIE values (or other environment lighting/color illumination descriptors) to appropriate ICC Profiles and Color LUTs. Since each printing device 28, such as a digital press, may use specific ICC “Device Link” profiles which ensure printed color consistency for a given device type and model, the database to 60 may also contain a mapping of “Device Link” ICC Profiles. Device Link ICC Profiles are presently utilized to facilitate color consistency for a given press type/model.

Display/input device 262 comprises a device that allows the selection of a particular display illumination profile from database 260. In operation, a user of system 220 may use device 262 to identify or input to controller 24 the anticipated illumination conditions for the display of the image to be printed. In one implementation, processor 32, following instructions contained in memory 36, may prompt the user to input and illumination use for the display environment. In another implementation, processor 32, following instructions contained in memory 36, may prompt the user to select one of the display illumination profiles stored in database 260.

For example, in one implementation, display/input device 262 may comprise a touch screen with presents the different options available for display illumination profiles and which allows a person to select which particular display illumination profile is to be used when controller 24 outputs printer operational parameter adjustments 52 to printing device 28. In one implementation, the user may be prompted to input information regarding the display environment such as the exact geographic location, the exact physical location at the geographic location, the time of year and/or the time of day in which the image to be printed will be displayed for viewing. Upon receiving such input, controller 24 searches database 260 for an display illumination profile 266 matching the input display environment information. In another implementation, upon receiving such input, controller 24 searches database 260 for those display illumination profiles of display environments that most closely match the input display environment information, wherein the most closely matching display environments are presented to the user for final selection.

In yet other implementations, controller 24 may instead or additionally prompt the user to enter general information regarding the expected lighting conditions for the printed image. Rather than inputting specific location coordinates, the user may simply identify general conditions or the general type of lighting environment. For example, controller 24 may present different example types of display environments from which the user may choose, wherein controller 24 utilizes one of the stored display illumination profile 266 that most suits the selected type of display environment. Examples of types of display environments may include, but not limited to, room with no windows/ambient lighting, a room lit by an overhead light of x Watts, a wall illuminated by a spotlight of x Watts, an exterior wall facing in a southerly direction, an exterior wall facing in a easterly direction during the morning, a horizontal supporting surface/table illuminated by an overhead light or a group of overhead lights having a total of x Watts and so on. In such an implementation, the user does not need to measure illumination characteristics at the particular display site nor does the user have to input the exact coordinates of a specific location.

Database 260 facilitates the printing of multiple images by multiple different users for presentation at the same location or in the same display environment without each individual image being altered and adjusted. In contrast, a user may enter information regarding the display environment are identify the display environment, wherein controller 24 consults database 260 and automatically makes the adjustments to the printer operational parameters regardless of the image itself or the users identification. A single display illumination profile 266 may be applied to the printing of different images, by different printing devices by different users.

FIG. 4 schematically illustrates an example printing system 320. Printing system 320 is similar to printing system 220 described above except that printing system 320 is specifically illustrated as comprising controller 24, print device 28, database 260 and display/input device 262 in a single printing unit 322. Printing unit 322 comprises a single housing that encloses each of controller 24, print device 28, database 260 and display size input device 262. In one implementation, database 260 may be updated with additional display illumination profiles 266 via a memory card slot or via wired or wireless communication. In one implementation, database 260 may be updated with additional display illumination profiles that are uploaded or transmitted in a wireless fashion across a network to database 260 within printing unit 322 from an optical spectrometer or other optical measuring device taking illumination or lighting measurements for the associated display environment.

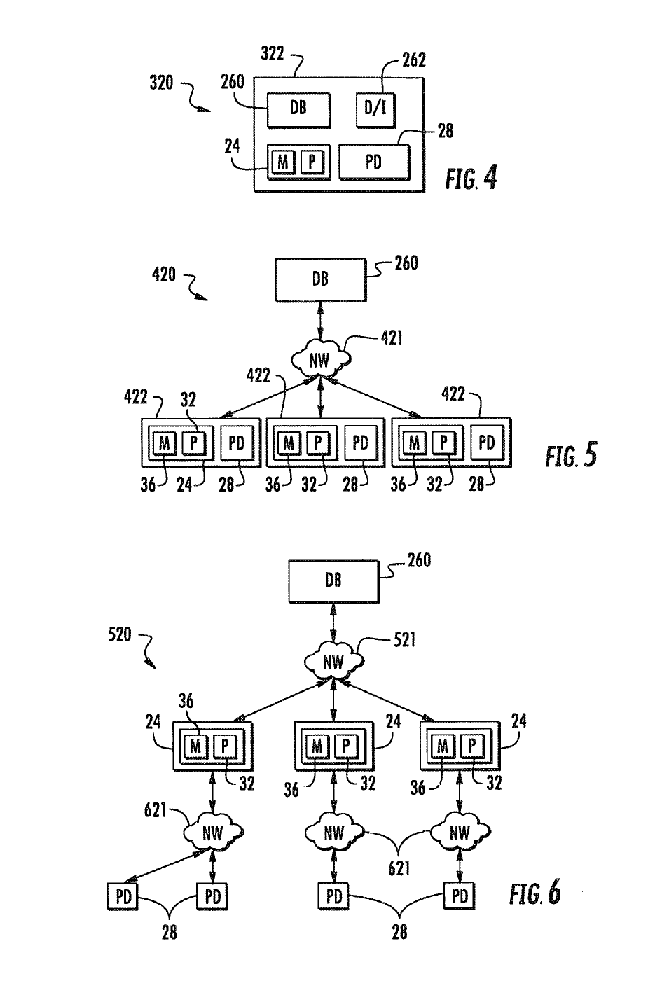

FIG. 5 schematically illustrates an example printing system 420. Printing system 420 is similar to printing system 220 described above except that printing system 420 utilizes a remote database 260 containing different display illumination profiles 266, wherein the remote database 260 communicates via a network 421 with each of a multitude of different printing units 422. In one implementation, database 260 comprises a network server that facilitates communication across network 421 and which provides access to the display illumination profiles 266 stored in database 260. Each printing unit 422 comprises a controller 24 and a print device 28 (described above). With printing system 420, each of the different printing is 422 share database 260 across network 421. As a result, illumination measurements may be taken at a first location to generate an display illumination profile that is uploaded database 260 at a second location, remote from the first location, and utilized by a printing unit 422 at a third location, different from the first location and the second location, to print an image for display at the first location. The printed image may be shipped from the third location to the first location for display. In such an implementation, database 260 may be managed and updated independent of those individual users of the individual printing 422.

FIG. 6 schematically illustrates an example printing system 520. Printing system 520 is similar to printing system 220 described above except that printing system 520 except that system 520 shares database 260 amongst multiple independent controllers 24 across network 521. Each of the independent controllers 24 provide adjustments to the operational parameters of different printing devices 28 across network (or networks) 621. In some implementations, a single controller 24 may provide printer operational parameter adjustments to multiple printers or print devices 28. As a result, controllers 24 may be remotely located with respect to the printing device 28 for which the adjustments signals are output by controllers 24. In such an implementation, system 520 may serve printing devices 28 that themselves omit controller 24, wherein the printing devices 28 may be updated or upgraded to communicate with controllers 24 to provide printed images customized for the display environment in which the individual printed images will be viewed.

Although the present disclosure has been described with reference to example implementations, workers skilled in the art will recognize that changes may be made in form and detail without departing from the spirit and scope of the claimed subject matter. For example, although different example implementations may have been described as including one or more features providing one or more benefits, it is contemplated that the described features may be interchanged with one another or alternatively be combined with one another in the described example implementations or in other alternative implementations. Because the technology of the present disclosure is relatively complex, not all changes in the technology are foreseeable. The present disclosure described with reference to the example implementations and set forth in the following claims is manifestly intended to be as broad as possible. For example, unless specifically otherwise noted, the claims reciting a single particular element also encompass a plurality of such particular elements. The terms “first”, “second”, “third” and so on in the claims merely distinguish different elements and, unless otherwise stated, are not to be specifically associated with a particular order or particular numbering of elements in the disclosure.

What is claimed is:

1. A printing system comprising:
a printer operational parameter adjustment controller comprising:
a processing unit; and
instructions, wherein the processing unit is to follow the instructions to adjust operational parameters of a printer located in a second environment, different than the first environment, based upon the stored display illumination profile for a first environment to print the image captured in a third environment different than the first environment.

2. The printing system of claim 1 further comprising a database, wherein the database stores display illumination profiles for multiple environments, including the first environment, wherein the printing system further comprises a user input, wherein the processing unit is to follow the instructions to prompt input of a selected one of the multiple environments for presentation of the image, wherein the processing unit is to follow the instructions to adjust operational parameters of the printer in the second environment based upon the selected one of the multiple environments.

3. The printing system of claim 1 further comprising a database storing display illumination profiles for multiple environments, including the first environment, wherein the database comprises a mapping of multiple display environments to printer specific color management profiles.

4. The printing system of claim 1 further comprising the printer, wherein the printer comprises the processing unit, the instructions and a database storing display illumination profiles for multiple environments.

5. The printing system of claim 1 further comprising:
a server comprising a database storing display illumination profiles for multiple environments; and
the printer, wherein the printer comprises the processing unit and the instructions and wherein the printer is in communication with the server across a network.

6. The printing system of claim 1 further comprising a server, the server comprising the processing unit, the instructions and a database storing display illumination profiles for multiple environments.

7. The printing system of claim 1, wherein the database stores display illumination profiles for multiple environments for presentation of the image, including the first environment, wherein the multiple environments comprise different lighting conditions at a same geographic location.

8. The printing system of claim 1, wherein the database stores display illumination profiles, the display illumination profiles selected from a group of display illumination profiles consisting of display lighting conditions at different times of a day for a geographic location and display lighting conditions at different times of the year for a geographic location.

9. The printing system of claim 1, wherein the first environment comprises captured illumination data for a location in which the image is to be displayed.

10. The printing system of claim 1, wherein the first environment comprises illumination values for a type of display environment for the image.

11. A method comprising:
receiving illumination data for a first environment in which an image captured in a second environment, different than the first environment, is to be displayed; and
adjusting operational parameters of a printer in a third environment different than the first environment based upon the illumination data for the first environment when printing the image.

12. The method of claim 11 comprising storing the image in an unaltered form from the image captured in the second environment.

13. The method of claim 11 comprising:
displaying available display environments for display of the image; and
prompting a user to select a display environment from the displayed available display environments, wherein the selected display environment is the first environment, the illumination data upon which the printing of the image is based.

14. The method of claim 11 further comprising:
displaying available types of display environments for display of the image; and
prompting user to select a type of display environment from the available types of display environments, wherein the selected type of display environment is the first environment, illumination data upon which the printing the images based.

15. A non-transitory computer-readable medium comprising instructions to direct a processor to:
receive illumination data for a display environment in which an image captured in a capture environment, different than the display environment, is to be displayed; and
output signals based upon the received illumination data for the display environment to adjust operational parameters of a printer in a printing environment different than the display environment based upon the illumination data for the data environment when printing the image.
